(19) United States
(12) Patent Application Publication
(10) Pub. No.: US 2014/0069609 A1
(43) Pub. Date: Mar. 13, 2014

(54) AIR-TEMPERATURE REGULATION DEVICE FOR A MACHINE TOOL

(71) Applicant: Daniel CAIHUZAC, Fenols (FR)

(72) Inventor: Daniel CAIHUZAC, Fenols (FR)

(21) Appl. No.: 14/018,428

(22) Filed: Sep. 5, 2013

(30) Foreign Application Priority Data
Sep. 6, 2012 (FR) 1258325

(51) Int. Cl. B23Q 11/12

(52) U.S. Cl. CPC B23Q 11/128
USPC 165/67

(57) ABSTRACT

A machine tool includes a frame providing the setting in motion of a tool and a workpiece holder module to be machined. The machine tool includes a plurality of heat exchangers inside of which flows a heat-transfer fluid, the exchangers being connected together and coming into contact with the frame as well as with the workpiece holder module, characterised by the fact that it comprises a climatization unit with scalable power.

### FIELD OF APPLICATION OF THE INVENTION

This invention relates to the field of machine tools and in particular to the adaptations making it possible to provide for their climatization in the best conditions.

### DESCRIPTION OF PRIOR ART

The climatization of machine tools is a functionality provided on certain machine tools and which has the role of controlling, modifying and/or maintaining as much as possible, the thermal conditions to which are subjected the various parts of a machine tool in order to guarantee the precision of the machining carried out. Indeed, the expansion or the retraction of a constituting element in relation to another is able to become a source of imprecision. These disadvantages become difficult to manage without climatization when the structures of the machine tool contain elements made of different materials and therefore of different expansion coefficients.

Existing climatization solutions consist in creating, inside the structure, boxes arranged with inlet and outlet orifices through which flows a heat-transfer fluid coming from a climatization service unit received by the machine tool. These solutions are therefore dedicated to each machine tool structure.

In addition, the recent development of high-speed machining techniques without cutting fluid or with a minimum quantity of liquid (called MQL machining) has for consequence the rising in temperature and the maintaining of this high temperature in the immediate vicinity of the machining station. However, although it is known to provide the climatization of the frames of machining tools, the climatization of the functional sub-assemblies providing the support of the workpiece is much rarer.

As such, if the need for climatization is known, it appears that the solution does not exist for all of the functional modules associated with the machine tool and/or the cost of implementing it remains prohibitive.

### DESCRIPTION OF THE INVENTION

Taking this state of things, the applicant conducted research aimed at providing the climatization for machining tools in order to propose a solution for climatization that is simple, inexpensive and which can be extended to the functional modules associated with the frame of the machine tool of which the workpiece holder module.

According to the invention, the machine tool which is of the type of that comprising a frame providing the setting in motion of a tool and a workpiece holder module to be machined, is remarkable in that it comprises a plurality of heat exchangers inside of which flows a heat-transfer fluid, said exchangers communicating between them and coming into contact with the frame as well as with the workpiece holder module.

This characteristic is particularly advantageous in that it offers a solution for climatization and for controlling the temperature of the machine tool that is particularly adaptable and easy to implement. The creation of a plurality of heat exchange zones on the walls of the machine tool will allow for the creation of a thermal barrier around the latter.

In addition, such a characteristic implies that a single climatization unit is required for all of the heat exchangers. Furthermore, such a solution authorises a large degree of flexibility in the shapes of exchangers in order to allow for an adaptation to a plurality of shapes of walls to be refrigerated/climatized. These exchangers can as such be provided on any portion constituting the machine tool or any equipment that is associated with the frame of the machine tool and which would require to be climatized. As such, for example, fluids and electrical supply cabinets can also be provided with said exchangers. Likewise, the machine tool can be of the type of that incorporating a workpiece holder device to its frame or of that receiving a workpiece holder device that is fixed to said frame.

In order to facilitate this flexibility and to allow for the designing of exchanger networks, the machine tool comprises several separated exchangers connected by means of flexible conduits. As such for example, the heat exchanger or exchangers of the workpiece holder are connected to the heat exchanger or exchangers of the frame of the machine tool when the workpiece holder module is fixed to said frame.

According to another particularly advantageous characteristic of the invention, each exchanger is constituted by a set of tubes that adopts the shape of a coil and is arranged in a pre-formed insulating panel that is fixed onto the walls of the frame or of the workpiece holder module. Each panel as such forms an independent element connected to the other panels by means of flexible tubes. Such a configuration makes it possible to manufacture the means of refrigeration independently of the frames that receive them and authorises the proposal of machine tools provided or not provided with means of refrigeration. Such a configuration with independent panels makes it possible to consider the refrigeration of existing machine tools.

According to another characteristic, each exchanger is constituted of a hollow body provided with an inlet orifice and an orifice and wherein flows a heat-transfer fluid, with the orifices authorising its connection to the other exchangers. According to an embodiment, these hollow bodies can form boxes of which a portion of the walls can be constituted by the walls of the machine tool.

According to a particularly advantageous characteristic of the invention, at least one exchanger is arranged under the frame of the machine tool and according to another characteristic, at least one exchanger is arranged under the workpiece holder module as such taking advantage of the flat portions available that are the closest top the zones to be refrigerated.

According to another particularly advantageous characteristic, the machine tool comprises a reversible climatization unit. The reversibility allows the machine tool to be used in non-tempered, cold or hot premises while still maintaining the precision of the workpieces produced.

According to another characteristic, the machine tool comprises a climatization unit with scalable power. This modulation makes it possible to control at any instant the temperature in the exchangers and therefore in the end, the geometry of the machine. The heat transfer fluid which flows in the exchangers is therefore regulated very finely in temperature.

According to an embodiment, said climatization unit comprises a motor provided with a variator reducing the temperature fluctuations of the heat-transfer fluid. According to another characteristic the climatization unit is used to control the temperature of the air inside the machining enclosure. The air drawn into the inside of the enclosure then first passes through a heat exchanger before penetrating into the machining zone.

As the fundamental concepts of the invention have just been exposed hereinabove in their most basic form, other details and characteristics shall appear more clearly when reading the following description and with regards to the annexed drawings, provided by way of a non-restricting example, an embodiment of a machine tool in accordance with the invention.

### BRIEF DESCRIPTION OF THE DRAWINGS

FIG. 1 is a drawing of a top view as an exterior perspective of an embodiment of a machine tool in accordance with the invention;

FIG. 2 is a drawing of a bottom view in perspective of the machine tool of FIG. 1;

FIG. 3 is a drawing according to the same point of view as that of FIG. 1, with only the refrigeration panels;

FIGS. 4 and 5 are top view and in perspective of an embodiment of a refrigeration panel.

### DESCRIPTION OF PREFERRED EMBODIMENTS

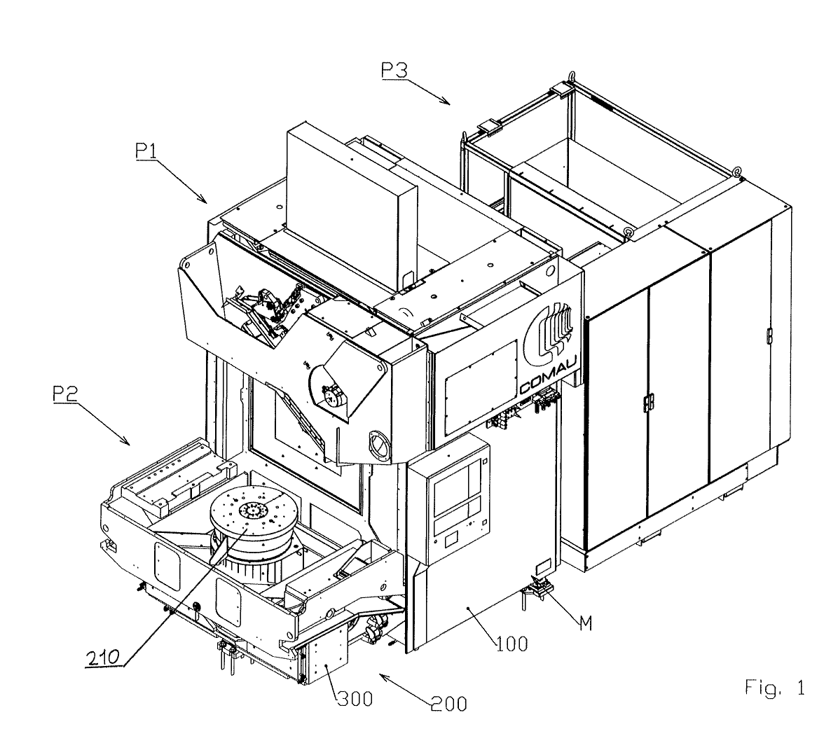

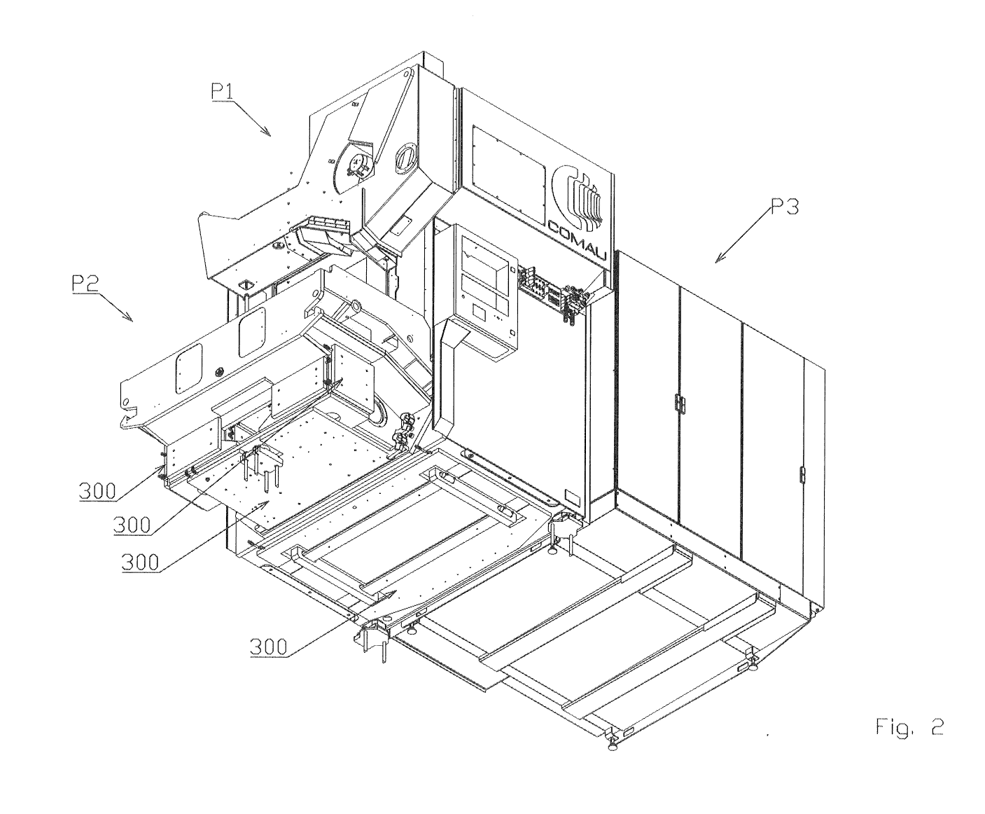

As shown in the drawings of FIGS. 1 and 2, the machining tool referenced as M as a whole comprises a plurality of functional modules and among these:
a station for setting in motion P1 including a frame 100 wherein is positioned a logic structure providing the setting in motion of a tool and whereon is fixed a control module M,
a machining station P2 including a workpiece holder module 200 and located on the front of the first station P1,
a supply and service station P3 receiving the means making it possible to provide the supply in energy of the other functional modules.

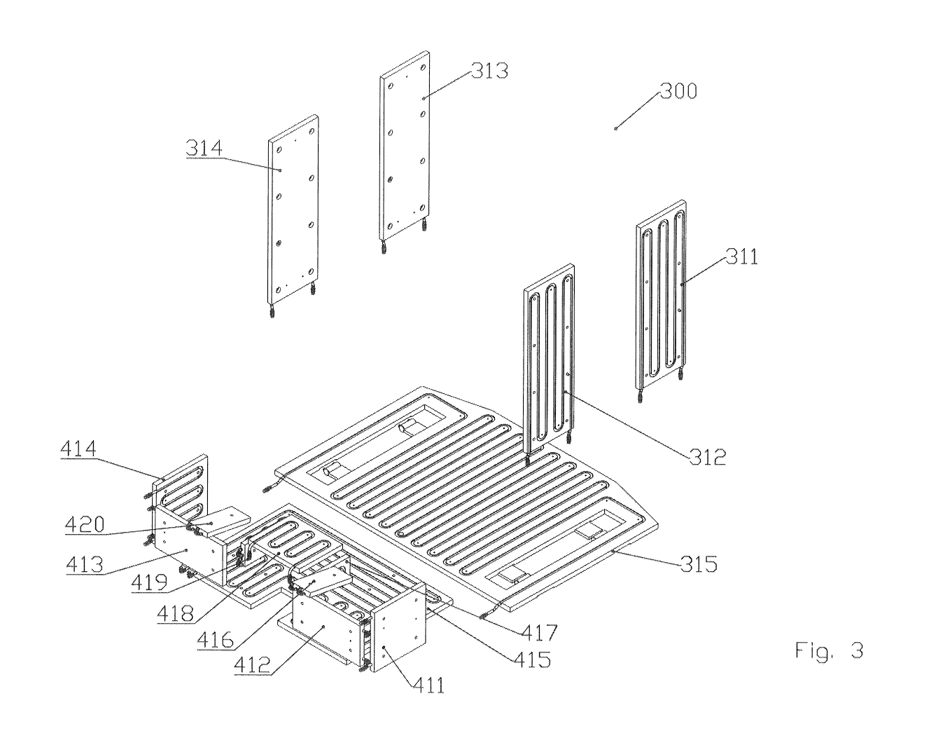

In accordance with the object of the invention, in order to provide in the best conditions the control of the temperature of the machine tool M, the frame 100 of the module for setting in motion and that of the workpiece holder module 200 receives on their walls, a plurality of exchangers here implemented by panels 300 connected together and forming a set of panels shown entirely in the drawing of FIG. 3.

The frame 100 is formed of walls constituting a substantially parallelepiped closed volume. As shown in the drawing of FIG. 3 showing the entire set of panels 300, panels 311, 312, 313, 314 are positioned in pairs on the internal faces of the longitudinal vertical walls of said frame 100. In addition, as shown in the drawing of FIG. 2, a horizontal panel 315 is fixed on the external face of the wall of the bottom or of the floor of the frame 100. This horizontal panel 315 fits between the frame 100 and the floor and is sized to cover almost all of the surface on the floor of said frame 100.

Due to its shape and its function as close as possible to the source of heat of the machining, the workpiece holder module 200 is associated with a plurality of panels with adapted sizes.

As for the frame 100 of the station 1, panels 411, 412, 413 and 414 are fixed to the vertical walls of the device. In addition, a horizontal plate 415 is fixed to the external face of the bottom wall or of the floor of the workpiece holder module 200 and covers almost all of it.

Other panels of smaller dimensions 416, 417, 418, 419 and 420 provide climatization as close as possible to the workpiece holder plateau 210 by being placed under the plateau 210, on either side and by being placed under the sheet metal for receiving chips.

Such a configuration provides a control of the temperature of the machine tool M and in particular of its machining station at the best cost.

All of these panels are connected together authorising as such the climatization of the entire machine tool via a single climatization unit.

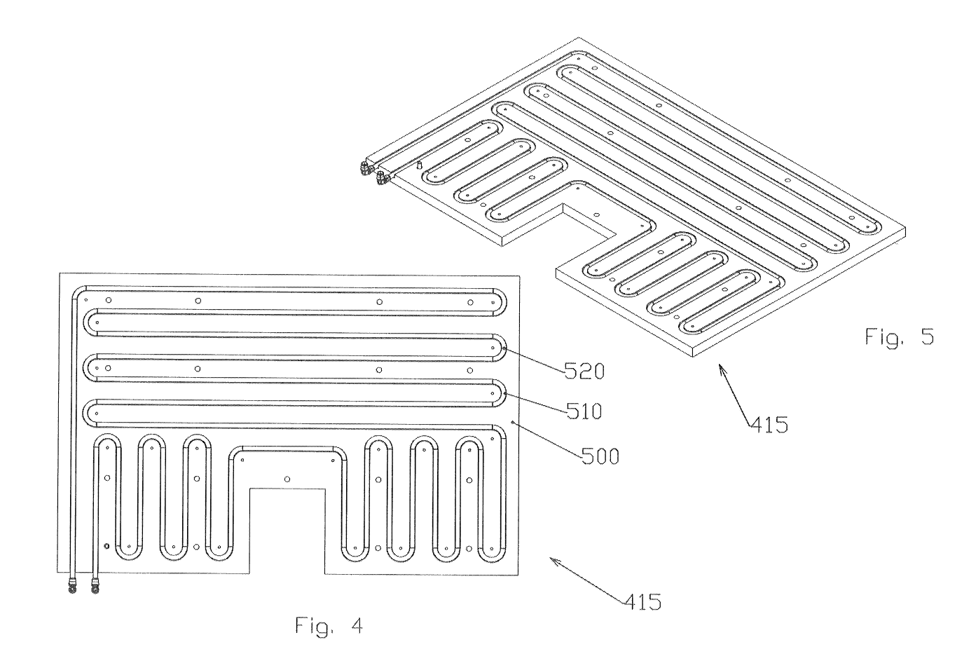

As shown on drawing of FIGS. 4 and 5, this refrigeration module has the form of a plate of plastic material 500 of which one face has been preformed with an indentation 510 wherein is received a pipe or tube 520 wherein flows a heat-transfer fluid. The panel is arranged in such a way that said pipe 520 comes into contact with the wall to which it is fixed. Each panel comprises two tube ends intended to form an inlet and an outlet in order to authorise its connection to the other panels and form the climatization network of the machine tool M.

According to the embodiment shown, said plate is made of polyurethane on one face in which has been preformed a groove with a circular profile wherein a copper pipe is arranged.

It is understood that the machine tool, which has just been described and shown hereinabove, has been described and shown for the purposes of divulging rather than as a limitation. Of course, various arrangements, modifications and improvements could be made to the example hereinabove, without however leaving the scope of the invention.

As such, for example, according to an embodiment not shown, each exchanger is comprised of a hollow body provided with an inlet orifice and an outlet orifice of heat transfer fluid in order to authorise its connection to the other exchangers.

1. A machine tool of the type of that comprising a frame providing the setting in motion of a tool and a workpiece holder module to be machined, comprising a plurality of heat exchangers inside of which flows a heat-transfer fluid, said exchangers being connected together and coming into contact with the frame as well as with the workpiece holder module, characterised by the fact that it comprises a climatization unit with scalable power.

2. A machine tool according to claim 1, characterised by the fact that it comprises several separated heat exchangers connected by means of flexible conduits.

3. A machine tool according to claim 1, characterised by the fact that each exchanger is comprised of a set of tubes which adopts the shape of a coil and is arranged in a preformed insulating panel that is fixed to the walls of the frame or of the workpiece holder module.

4. A machine tool according to claim 1, characterised by the fact that a heat exchanger is arranged under the frame of the machine tool.

5. A machine tool according to claim 1, characterised by the fact that an exchanger is arranged under the workpiece holder device.

6. A machine tool according to claim 1, characterised by the fact that it comprises a reversible climatization unit.

7. A machine tool according to claim 1, characterised by the fact that each exchanger is comprised of a hollow body provided with an inlet and an outlet and wherein flows a heat-transfer fluid.

8. A machine tool according to claim 1, characterised by the fact that the fluids and electrical supply cabinets are provided with said exchangers.
